(19) United States
(12) Patent Application Publication
(10) Pub. No.: US 2025/0243323 A1
(43) Pub. Date: Jul. 31, 2025

(54) BENZOXAZINE COMPOSITION AND USE THEREOF

(71) Applicant: KANEKA CORPORATION, Osaka (JP)

(72) Inventor: Takefumi Furuta, Osaka (JP)

(73) Assignee: KANEKA CORPORATION, Osaka (JP)

(21) Appl. No.: 18/588,572

(22) PCT Filed: Sep. 7, 2022
(86) PCT No.: PCT/JP2022/033500

§ 371 Date: Feb. 27, 2024

(30) Foreign Application Priority Data
Sep. 8, 2021 (JP) 2021-146402

(51) Int. Cl. C08G 73/02; C08J 5/24; C08K 3/01; C08K 5/1515

(52) U.S. Cl. CPC C08G 73/0233; C08J 5/24; C08K 3/01; C08K 5/1515

(57) ABSTRACT

An object of the present invention is to provide a benzoxazine composition the cured product of which has excellent self-repairability. A benzoxazine composition in accordance with an embodiment of the present invention includes: a specific benzoxazine compound; and a specific compound having an epoxy group and/or a specific transesterification catalyst, so that the above object is achieved.

### TECHNICAL FIELD

The present invention relates to a benzoxazine composition and use thereof.

### BACKGROUND ART

As a raw material of electronic parts, semiconductor encapsulating materials, and the like, a phenol resin, an epoxy resin, or the like has been used. In recent years, a benzoxazine resin has been used because of, in particular, its excellent heat resistance.

For example, Patent Literature 1 indicates that a resin composition excellent in flowability is obtained by using a resin having a benzoxazine structure and an epoxy resin in combination such that the ratio between the number of moles of the benzoxazine structure and the number of moles of an epoxy group is a specific ratio.

### CITATION LIST

### Patent Literature

### Patent Literature 1

International Publication No. WO 2015/190131

### SUMMARY OF INVENTION

### Technical Problem

However, Patent Literature 1 does not provide any disclosure or suggestion of the self-repairability of the resin composition. An object of the present invention is to provide a benzoxazine composition the cured product of which has excellent self-repairability.

### Solution to Problem

The inventors of the present invention diligently studied the solution to the above problem. As a result, the inventors found that the cured product of a benzoxazine composition which includes (i) a specific benzoxazine compound and (ii) a specific compound having at least two epoxy groups and/or at least one type of transesterification catalyst has excellent self-repairability. This led to completion of the present invention.

That is, an aspect of the present invention is a benzoxazine composition which includes: a benzoxazine compound represented by the following Formula (1), the benzoxazine compound being a component (A); and
an epoxy group-containing compound represented by the following Formula (2), the epoxy group-containing compound being a component (B), and/or a transesterification catalyst, which is component (C),
the component (C) being at least one selected from the group consisting of an acidic compound, a basic compound, a phosphorous compound, and a salt of a metal selected from among zinc, tin, zirconium, lead, titanium, manganese, magnesium, antimony, and germanium.

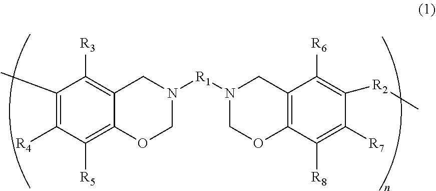

where: n is an integer; R₁ and R₂ are each an aromatic group and/or an aliphatic group, and either R₁ or R₂ or both R₁ and R₂ contain(s) at least one ester group; and R₃ to R₈ are each independently selected from the group consisting of a hydrogen atom, a halogen atom, an alkyl group, an alkyl halide group, a hydroxy group, a carboxyl group, an amino group, and an alkoxy group.

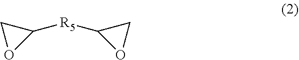

where R₉ is an aromatic group and/or an aliphatic group.

### Advantageous Effects of Invention

With an aspect of the present invention, it is possible to provide a benzoxazine composition the cured product of which has excellent self-repairability.

### BRIEF DESCRIPTION OF DRAWINGS

FIG. 1 is a diagram illustrating an example of a mechanism of damage repair on the surface of a cured product of a benzoxazine composition in accordance with an embodiment of the present invention.

FIG. 2 illustrates observation images of scratches made on cured products in accordance with Examples of the present invention.

### DESCRIPTION OF EMBODIMENTS

The following description will discuss an embodiment of the present invention, but the present invention is not limited to the embodiment. As used herein, a numerical range expressed as “A to B” means “not less than A and not more than B” unless otherwise specified.

### [1. Benzoxazine Composition]

A benzoxazine composition (hereinafter, also referred to as the present benzoxazine composition) in accordance with an embodiment of the present invention includes: a benzoxazine compound represented by the following Formula (1), the benzoxazine composition being a component (A); and an epoxy group-containing compound represented by the following Formula (2), the epoxy group-containing compound being a component (B), and/or a transesterification catalyst, which is a component (C). The component (C) is at least one selected from the group consisting of an acidic compound, a basic compound, a phosphorous compound, and a salt of a metal selected from among zinc, tin, zirconium, lead, titanium, manganese, magnesium, antimony, and germanium.

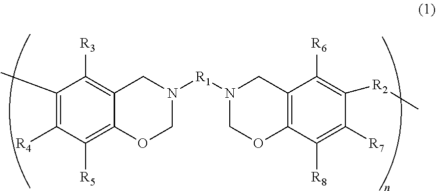

where: n is an integer; R₁ and R₂ are each an aromatic group and/or an aliphatic group, and either R₁ or R₂ or both R₁ and R₂ contain(s) at least one ester group; and R₃ to R₈ are each independently selected from the group consisting of a hydrogen atom, a halogen atom, an alkyl group, an alkyl halide group, a hydroxy group, a carboxyl group, an amino group, and an alkoxy group.

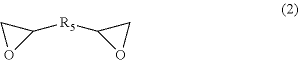

where R₉ is an aromatic group and/or an aliphatic group.

As described above, the inventors of the present invention successfully produced a cured product having excellent self-repairability, by curing a benzoxazine composition which includes: a specific benzoxazine compound; and a specific compound having at least one epoxy group and/or at least one type of transesterification catalyst. This is a surprise because there was not such a benzoxazine composition the cured product of which also had excellent self-repairability.

As used herein, the phrase “having self-repairability” means that when a cured product having a scratch is heated, the width and/or length of the scratch become(s) smaller than before the heating.

As used herein, the phrase “having excellent self-repairability” means that when a cured product having a scratch which is not more than 50 m in width and approximately 2 mm in length is heated at 235° C. for one hour, the average (average repair rate) of the respective repair rates at three locations is not less than 30%, the three locations being at or near the left end, the right end, and the center of the scratch in the longitudinal direction, each of the repair rates being represented by the following formula.

$$Repair rate ( \% ) = \{ 1 - ( width ( μ m ) of scratch after heating / width ( μ m ) of \text{} scratch before heating ) \} \times 100$$

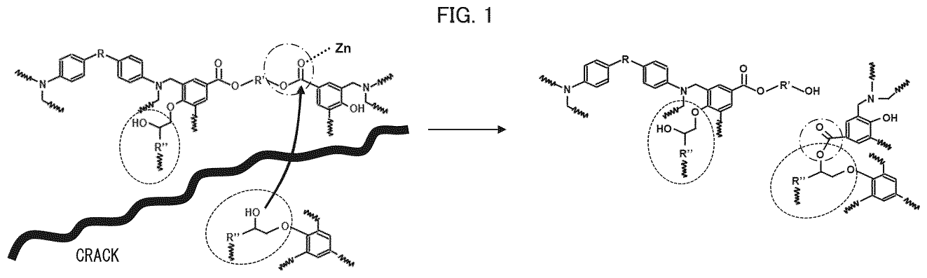

The self-repairability mechanism of the cured product of the present benzoxazine composition can be, for example, as illustrated in FIG. 1. It should be noted that the reaction formula illustrated in FIG. 1 is an example of the reaction occurring when compounds indicated in Examples are contained as the component (A) to component (C) in the present benzoxazine composition, and the reaction mechanism of the present invention is not limited to this example.

The repair mechanism of the cured product will be described below in detail with use of FIG. 1. First, when the present benzoxazine composition is cured by heating, the ring of the benzoxazine moiety of the component (A) contained in the cured product opens, and a phenolic hydroxyl group is generated accordingly. The phenolic hydroxyl group and the component (B) react together, and an aliphatic hydroxyl group, which is a portion enclosed by a broken line in FIG. 1, is generated accordingly. When the cured product is further heated in a case where damage (crack) is caused in the cured product, the aliphatic hydroxyl group and an ester group react together, the ester group being a portion enclosed by a dot-and-dash line in FIG. 1, of the component (A) which is interacting with the component (C). Due to this reaction, bond exchange occurs. As a result, the damage caused in the cured product is repaired. Incidentally, bond exchange occurs also in the absence of the component (C), although the efficiency thereof is lower than in the presence of the component (C). Further, the phenolic hydroxyl group can react with the ester group, although the reactivity of such a reaction is lower than the reactivity of the aliphatic hydroxyl group with the ester group. Therefore, bond exchange can occur even in the absence of the component (B). Thus, with a combined use of the component (A) and at least one selected from the group consisting of the component (B) and component (C), it is possible to obtain a cured product having excellent self-repairability.

As above, with the present benzoxazine composition, it is possible to obtain a cured product capable of self-repair, by heating, which is a simple operation. This makes it possible to use a cured product of the present benzoxazine composition over a long period of time.

In addition, the configuration as described above makes it possible to repair a cured product by heating for reuse even when the cured product is damaged. This enables contribution to the achievement and implementation of Goal 12 “Ensure sustainable consumption and production patterns” of the sustainable development goals (SDGs).

The present benzoxazine composition includes the component (A) and includes the component (B) and/or the component (C). In other words, a combination of the components contained in the present benzoxazine composition may be the combination of the component (A) and the component (B), may be the combination of the component (A) and the component (C), or may be the combination of the component (A), the component (B), and the component (C).

The present benzoxazine composition preferably includes the component (A), the component (B), and the component (C). The inclusion of the component (A), the component (B), and the component (C) in the present benzoxazine composition improves the self-repairability of a cured product obtained by curing the present benzoxazine composition.

### <1-1. Component (A)>

The component (A) is a benzoxazine compound represented by the following Formula (1).

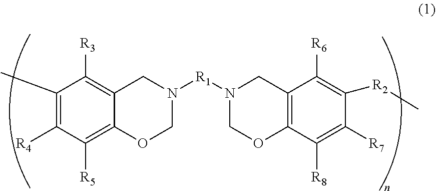

In Formula (1), n is an integer. The component (A) has a number average molecular weight which is preferably not more than 100,000, more preferably not more than 50,000, and even more preferably not more than 25,000, from the viewpoint of the mobility of the molecules required for self-repair. In addition, the component (A) has a weight average molecular weight which is preferably not more than 1,000,000, more preferably not more than 500,000, and even more preferably not more than 100,000. Since n of the above Formula (1) determined by GPC measurement is calculated in the form of an average value, it is difficult to accurately identify the range of n.

R₁ and R₂ are each an aromatic group and/or an aliphatic group. For example, a combination of R₁ and R₂ may be such that R₁ is an aromatic group and R₂ is an aliphatic group, or may be such that R₁ is an aliphatic group and R₂ is an aromatic group.

Either R₁ or R₂ or both R₁ and R₂ contain(s) at least one ester group. That is, either R₁ or R₂ alone may have an ester group, or both R₁ and R₂ may have an ester group. The ester group may be bound to either an aromatic group or an aliphatic group. For example, the ester group may be bound to the both ends of an aliphatic group. For example, R₁ may be an aromatic group, and R₂ may be an aliphatic group containing ester groups at the respective ends thereof.

Examples of the aromatic group include a phenylene group, a biphenylene group, a naphthylene group, an anthranylene group, a phenanthrylene group, a pyrenylene group, a coronylene group, a terphenylene group, a furanylene group, a thienylene group, and a fluorenylene group.

In the present specification, examples of the aromatic group also include a structure in which not less than two groups of the same type or different types of the above phenylene group, biphenylene group, naphthylene group, anthranylene group, phenanthrylene group, pyrenylene group, coronylene group, terphenylene group, furanylene group, thienylene group, and fluorenylene group are connected via one bivalent linking group or two or more bivalent linking groups. In addition, examples of the aromatic group also include a non-benzene aromatic group and a heteroaromatic group. Examples of the non-benzene aromatic group include annulene, azulene, tropone, metallocene, and any other aromatic compound having a three-membered ring structure, a five-membered ring structure, or a seven-membered ring structure.

Examples of the bivalent linking group include an alkylene group, an ether group, a carbonyl group, an amide group, an imino group, an azo group, a sulfide group, a sulfonyl group, a sulfide group, an isopropylidene group, and a hexafluorinated isopropylidene group.

In a case where the aromatic group has a substituent, examples of the substituent include a halogen atom, an alkyl group, a cycloalkyl group, an alkyl halide group, a hydroxy group, a carboxyl group, an amino group, an alkoxy group, a cyano group, an aryloxy group, and an aralkyloxy group.

The number of carbons of the aromatic group is preferably 6 to 50, more preferably 6 to 40, and even more preferably 6 to 30.

The aliphatic group may be either in a chain form or cyclic, and may be saturated or unsaturated. In a case where the aliphatic group is in a chain form, the aliphatic group may be linear, or may be branched. Examples of the aliphatic group in a chain form include an alkylene group, an alkenylene group, and an alkynylene group. Examples of the cyclic aliphatic group include a cycloalkylene group.

Examples of the alkylene group include a methylene group, an ethylene group, a propylene group, a butylene group, a pentylene group, and a hexylene group. Examples of the alkenylene group include a vinylene group, a 1-methylvinylene group, a propenylene group, a butenylene group, and a pentenylene group. Examples of the alkynylene group include an ethynylene group, a propynylene group, a butynylene group, a pentynylene group, and a hexynylene group. Examples of the cycloalkylene group include a cyclopropylene group, a cyclobutylene group, a cyclopentylene group, and a cyclohexylene group.

In addition, at least one hydrogen atom contained in the aliphatic group may be substituted with a halogen atom, a hydroxy group, or an alkoxy group.

The number of carbons of the aliphatic group is preferably 1 to 20 and more preferably 1 to 10. When the number of carbons falls within the above range, the cured product is excellent in self-repairability.

In Formula (1), R₃ to R₈ are each independently selected from the group consisting of a hydrogen atom, a halogen atom, an alkyl group, an alkyl halide group, a hydroxy group, a carboxyl group, an amino group, and an alkoxy group. R₃ to R₈ are preferably selected from the group consisting of a hydrogen atom, a halogen atom, an alkyl group, and an alkyl halide group. For example, all of R₃ to R₈ may be hydrogen atoms.

For example, as the component (A), a compound represented by the following Formula (3) can be used.

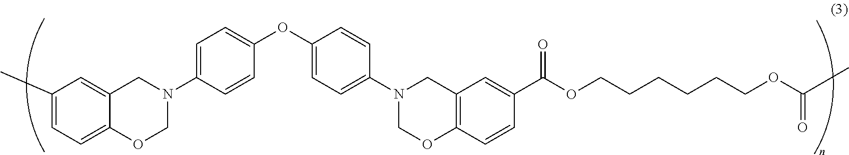

The amount of the component (A) contained in the present benzoxazine composition is preferably 30% by weight to 99% by weight, more preferably 35% by weight to 98% by weight, and even more preferably 40% by weight to 97% by weight. When the amount of the component (A) contained falls within the above range, the cured product is excellent in self-repairability.

The component (A) may be chemically synthesized, or a commercially available product may be used as the component (A). In a case where the component (A) is chemically synthesized, the synthesis can be performed with use of any method, which is not particularly limited. For example, the synthesis can be performed by the method described in Production Example 1 and Production Example 2, which are described below.

Here is a description of an example of the method for synthesizing the component (A). The component (A) is obtained, for example, by mixing and heating components which are a diphenol component, a diamine component, and a component such as formaldehyde or paraformaldehyde, which produces formaldehyde. As a specific example, components which are a diphenol component, a diamine component, and a component such as formaldehyde or paraformaldehyde, which produces formaldehyde, are first mixed such that the diphenol component and the diamine component are approximately equal in amount to each other in terms of the stoichiometric ratio, and are then allowed to react together in a solvent at a temperature not more than 150° C., in particular at a temperature not more than 100° C., so that the component (A) is obtained. In the above reaction, all or some of the reaction steps may be carried out in an atmosphere of an inert gas such as a nitrogen gas or an argon gas or in a vacuum.

### <1-2. Component (B)>

The component (B) is an epoxy group-containing compound represented by the following Formula (2).

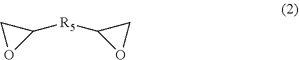

where R₉ is an aromatic group and/or an aliphatic group.

In a case where the present benzoxazine composition contains the component (B), the ratio (X)/(Y) of the equivalent (X) of a phenolic hydroxyl group generated by the component (A) at the time of curing the present benzoxazine composition to the equivalent (Y) of an epoxy group of the component (B) is preferably not less than 0.25, more preferably not less than 0.4, and even more preferably not less than 0.5. The upper limit of the ratio (X)/(Y) is not particularly limited, but may be, for example, not more than 5. The ratio (X)/(Y) can be adjusted as appropriate according to the weight ratio between the component (A) and the component (B). When the ratio (X)/(Y) falls within the above range, the self-repairability of a cured product obtained is improved.

The component (B) is preferably an epoxy resin. The epoxy resin is preferably at least one selected from the group consisting of a bisphenol A epoxy resin, a bisphenol F epoxy resin, a novolac type epoxy resin, a brominated epoxy resin, a hydrogenated epoxy resin, a bisphenol S epoxy resin, a naphthalene type epoxy resin, a phosphorus-containing epoxy resin, a biphenyl type epoxy resin, a tris(hydroxyphenyl)methane type epoxy resin, a tetraphenylethane type epoxy resin, and a dicyclopentadiene type epoxy resin, more preferably a bisphenol A epoxy resin or a bisphenol F type epoxy resin, and even more preferably bisphenol A type epoxy resin. When the component (B) is the epoxy resin, the reactivity thereof with the component (A) is excellent, and the cured product of the benzoxazine composition is excellent in heat resistance and mechanical properties.

The component (B) may be chemically synthesized, or a commercially available product may be used as the component (B). As the commercially available product, the following products can be used, for example.

Examples of the bisphenol A epoxy resin include: JER828EL (trade name) manufactured by Mitsubishi Chemical; jER828, jER 1001, and jER1002 (trade names) manufactured by Japan Epoxy Resin Co., Ltd.; Adeka Resin EP-4100E and Adeka Resin EP-4300E (trade names) manufactured by ADEKA CORPORATION; RE-310S and RE-410S (trade names) manufactured by Nippon Kayaku Co., Ltd.; EPICLON 840S, EPICLON 850S, EPICLON 1050, and EPICLON 7050 (trade names) manufactured by DIC Corporation; and Epototo YD-115, Epototo YD-127, and Epototo YD-128 manufactured by Tohto Kasei Co., Ltd.

Examples of the bisphenol F epoxy resin include: jER806 and jER807 (trade names) manufactured by Japan Epoxy Resin Co., Ltd.; Adeka Resin EP-4901E, Adeka Resin EP-4930, and Adeka Resin EP-4950 (trade names) manufactured by ADEKA CORPORATION; RE-303S, RE-304S, RE-403S, and RE-404S (trade names) manufactured by Nippon Kayaku Co., Ltd.; EPICLON 830 and EPICLON 835 (trade names) manufactured by DIC Corporation; and Epototo YDF-170, Epototo YDF-175S, and Epototo YDF-2001 (trade names) manufactured by Tohto Kasei Co., Ltd.

Examples of the novolac type epoxy resin include a phenol novolac type epoxy resin and a cresol novolac type epoxy resin. Examples of the phenol novolac type epoxy resin include: jER152 and jER154 (trade names) manufactured by Japan Epoxy Resin Co., Ltd.; EPPN-201-L (trade name) manufactured by Nippon Kayaku Co., Ltd.; EPICLON N-740 and EPICLON N-770 (trade names) manufactured by DIC Corporation; and Epototo YDPN-638 (trade name) manufactured by Tohto Kasei Co., Ltd. Examples of the cresol novolac type epoxy resin include: EOCN-1020, EOCN-102S, EOCN-103S, and EOCN-104S (trade names) manufactured by Nippon Kayaku Co., Ltd.; and EPICLONE N-660, EPICLON N-670, EPICLON N-680, and EPICLON N-695 (trade names) manufactured by DIC Corporation.

Examples of the brominated epoxy resin include EPICLON 152 and EPICLON 153 (trade names) manufactured by DIC Corporation.

Examples of the hydrogenated type epoxy resin include a hydrogenated bisphenol A epoxy resin. Examples of the hydrogenated bisphenol A epoxy resin include: jERYX8000, jERYX8034, and jERYL7170 (trade names) manufactured by Japan Epoxy Resin Co., Ltd.; Adeka Resin EP-4080E (trade name) manufactured by ADEKA CORPORATION; EPICLON EXA-7015 (trade name) manufactured by DIC Corporation; and Epototo YD-3000 and Epototo YD-4000D (trade names) manufactured by Tohto Kasei Co., Ltd.

Examples of the bisphenol S epoxy resin include EPICLON EXA-1514 (trade name) manufactured by DIC Corporation.

Examples of the naphthalene type epoxy resin include: EPICLON HP-4032, EPICLON HP-4700, and EPICLON HP-4200 (trade names) manufactured by DIC Corporation; and NC-7000L (trade name) manufactured by Nippon Kayaku Co., Ltd.

Examples of the biphenyl type epoxy resin include: jERYX4000, jERYL6121H, jERYL6640, and jERYL6677 (trade names) manufactured by Japan Epoxy Resin Co., Ltd.; and NC-3000 and NC-3000H (trade names) manufactured by Nippon Kayaku Co., Ltd.

Examples of the dicyclopentadiene type epoxy resin include: XD-1000 (trade name) manufactured by Nippon Kayaku Co., Ltd.; and EPICLON HP-7200 (trade name) manufactured by DIC Corporation.

For example, as the above epoxy resin, JER828EL (trade name) manufactured by Mitsubishi Chemical, which is bisphenol A epoxy resin and represented by the following Formula (4), can be used.

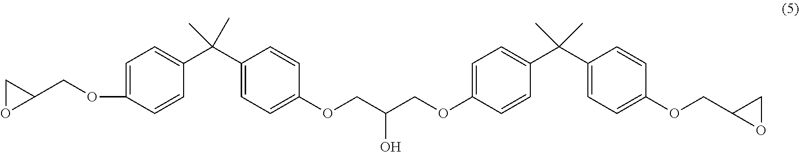 [SMILES: CC(C)(c1ccc(OCC(O)COc2ccc(C(C)(C)c3ccc(OCC4CO4)cc3)cc2)cc1)c1ccc(OCC2CO2)cc1]

### <Component (C)>

The component (C) is at least one transesterification catalyst selected from the group consisting of an acidic compound, a basic compound, a phosphorous compound, and a salt of a metal selected from among zinc, tin, zirconium, lead, titanium, manganese, magnesium, antimony, and germanium. Among these, the component (C) is preferably at least one selected from the group consisting of salts of zinc, tin, zirconium, lead, and titanium, more preferably at least one selected from the group consisting of salts of zinc, tin, zirconium, and titanium, and even more preferably a salt of zinc, from the viewpoint of the balance among performance as a catalyst, availability, cost, and handling. The component (C) may be a single type of transesterification catalyst, or may be a mixture of at least two types of transesterification catalysts.

Examples of the acidic compound include hydrochloric acid, sulfuric acid, nitric acid, acetic acid, phosphoric acid, and sulfonic acid. Examples of the basic compound include lithium hydroxide, potassium hydroxide, sodium hydroxide, and amines. Examples of the phosphorous compound include triphenylphosphine. Examples of the salt include an acetate, a nitrate, a hydrochloride, a sulfate, and a phosphate. For example, zinc acetate may be used as the component (C).

The amount of the component (C) contained in the present benzoxazine composition is preferably 1 mol % to 20 mol %, more preferably 3 mol % to 18 mol %, and even more preferably 5 mol % to 15 mol %, relative to the ester bonds contained in the component (A). When the amount of the component (C) contained falls within the above range, the cured product is excellent in self-repairability.

### (Others)

The present benzoxazine composition may include a filler, a mold release, a flame retardant, a colorant, a coupling agent, and the like, where necessary. These may be mixed during production of the present benzoxazine composition, or may be mixed during curing of the present benzoxazine composition.

### [2. Cured Product]

A cured product can be obtained by curing the present benzoxazine composition. A curing method to form the cured product is not particularly limited. However, because the present benzoxazine composition has a thermosetting property, the curing of the present benzoxazine composition may be performed by heating.

In a case where the present benzoxazine composition is cured to form a cured product, the present benzoxazine composition may be dissolved in a solvent so as to be in the form of a solution composition, and then heated. The solvent is not particularly limited, but may be, for example, an amide solvent such as N,N-dimethylacetamide, N,N-dimethylformamide, or N-methyl-2-pyrrolidone, from the viewpoint of the solubility of the composition.

The heating temperature at which the present benzoxazine composition is cured by heating is not particularly limited, provided that it is possible to sufficiently cure the present benzoxazine composition, but may be, for example, 120° C. to 240° C. The heating time is not particularly limited as well, but may be, for example, five hours to 24 hours. The heating temperature may be constant for the duration of heating, or may be changed as appropriate where necessary. In addition, the heating may be carried out at a time, or the heating may be carried out so as to be divided into several heating stages. Also in a case where the heating is carried out in the several heating stages, the heating temperature and the heating time need not be constant.

The cured product preferably contains reinforcing fibers from the viewpoint of improving the mechanical strength of the cured product. Examples of the reinforcing fibers include inorganic fibers, organic fibers, metal fibers, and reinforcing fibers of a hybrid configuration obtained by combination of the foregoing types of fibers. The reinforcing fibers can be of a single type or can be of two or more types.

Examples of the inorganic fibers include carbon fibers, graphite fibers, silicon carbide fibers, alumina fibers, tungsten carbide fibers, boron fibers, and glass fibers. Examples of the organic fibers include aramid fibers, high-density polyethylene fibers, and any other typical nylon fibers and polyester fibers. Examples of the metal fibers include fibers of stainless steel, iron, or the like. Examples of the metal fibers also include carbon coated metal fibers obtained by coating metal fibers with carbon. Among these, carbon fibers are preferable as the reinforcing fibers from the viewpoint of improving the strength of the cured product.

Although typically having undergone a sizing treatment, the carbon fibers may be used without undergoing any treatment. Alternatively, where necessary, fibers obtained with use of a small amount of sizing agent may be used, or the sizing agent can be removed by an existing method such as an organic solvent treatment or a heat treatment. In addition, a fiber bundle of carbon fibers is opened with use of an air, a roller, or the like, so that a treatment which facilitates the complete spread of a resin between the individual carbon fibers may be applied.

The cured product has a glass transition temperature (Tg) which is preferably not less than 110° C., more preferably not less than 120° C., and even more preferably not less than 130° C. When the Tg of the cured product is not less than 110° C., the cured product can be said to be excellent in heat resistance. The upper limit of Tg is not particularly limited, but may be practically not more than 300° C.

The cured product has a 5% weight loss temperature (Td5) which is preferably not less than 290° C., more preferably not less than 300° C., and even more preferably not less than 310° C. When the Td5 of the cured product is not less than 290° C., the cured product is not only excellent in heat resistance, but also less likely to deteriorate during the repair carried out by the method described below. As used herein “5% weight loss temperature (Td5)” means a temperature at the time when the weight of the cured product is reduced by 5% due to pyrolysis.

The cured product has an average repair rate which is preferable not less than 30%, more preferably not less than 40%, even more preferably not less than 50%, and even more preferably not less than 60%. When the average repair rate of the cured product is not less than 30%, the cured product can be said to have excellent self-repairability. It is more preferable that the average repair rate of the cured product be higher. For example, the average repair rate may be not more than 100%, or may be not more than 90%. The phrase “excellent self-repairability” and the term “average repair rate” in the present specification are as described in the above section [1. Benzoxazine composition].

The cured product is suitably applicable to electronic materials such as electronic parts, printed wiring boards and laminated boards for a printed wiring board, semiconductor encapsulating materials, and semiconductor-mounted modules, motor vehicles or vehicles, aircraft parts, building materials, machine tools, etc. The cured product can be used in, in particular, parts of these materials that are required to have heat resistance.

### [3. Method for Repairing Cured Product]

A method for repairing a cured product in accordance with an embodiment of the present invention includes a step of heating a cured product of the present benzoxazine composition. Therefore, with the present benzoxazine composition, it is possible to repair the cured product simply by heating.

The heating temperature and heating time during the repair of the cured product can be set as appropriate according to the composition of the cured product, etc. For example, the heating temperature may be 50° C. to 300° C., may be 100° C. to 250° C., or may be 200° C. to 250° C. For example, the heating time may be five minutes to five hours, or may be 30 minutes to two hours.

### [4. Prepreg or Semipreg]

A prepreg or semipreg in accordance with an embodiment of the present invention is obtained by impregnating reinforcing fibers with the present benzoxazine composition. As used herein, a semipreg means a complex obtained by causing reinforcing fibers to be partially impregnated (be in a semi-impregnated state) with the present benzoxazine composition, so that the reinforcing fibers unite with the present benzoxazine composition.

A prepreg can be obtained from the semipreg. For example, by further heating and melting the semipreg to impregnate the reinforcing fibers with the resin, it is possible to obtain a prepreg.

As the reinforcing fibers for use in a prepreg or semipreg, the reinforcing fibers described in the above section [2. Cured product] can be used as appropriate.

The content of resin with which the reinforcing fibers are impregnated is preferably 10% by weight to 60% by weight, and more preferably 20% by weight to 50% by weight. The content of resin means the ratio of the weight of the resin to the sum of the weights of the resin and the reinforcing fibers.

With the prepreg or semipreg, it is possible to prepare a printed wiring board by, for example, applying heat and pressure to the prepreg or semipreg together with metal foil to prepare a laminated board for the printed wiring board, and further forming circuitry on the laminated board. The printed wiring board thus prepared is excellent in heat resistance, machine characteristics, etc., and therefore suitably used as a semiconductor-mounted substrate or the like.

The present invention is not limited to the embodiments, but can be altered by a skilled person in the art within the scope of the claims. The present invention also encompasses, in its technical scope, any embodiment derived by combining technical means disclosed in differing embodiments.

An aspect of the present invention may include the following configurations.
<1> A benzoxazine composition including: a benzoxazine compound represented by the following Formula (1), the benzoxazine compound being a component (A); and
an epoxy group-containing compound represented by the following Formula (2), the epoxy group-containing compound being a component (B), and/or a transesterification catalyst, which is component (C),
the component (C) being at least one selected from the group consisting of an acidic compound, a basic compound, a phosphorous compound, and a salt of a metal selected from among zinc, tin, zirconium, lead, titanium, manganese, magnesium, antimony, and germanium.

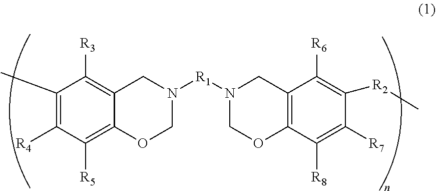

where: n is an integer; R₁ and R₂ are each an aromatic group and/or an aliphatic group, and either R₁ or R₂ or both R₁ and R₂ contain(s) at least one ester group; and R₃ to R₈ are each independently selected from the group consisting of a hydrogen atom, a halogen atom, an alkyl group, an alkyl halide group, a hydroxy group, a carboxyl group, an amino group, and an alkoxy group.

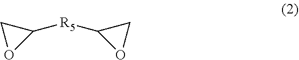

where R₉ is an aromatic group and/or an aliphatic group.
<2> The benzoxazine composition described in <1>, in which the benzoxazine composition includes the component (B), and when cured, the benzoxazine composition has a ratio (X)/(Y) of not less than 0.25, the ratio (X)/(Y) being a ratio of an equivalent (X) of a phenolic hydroxyl group generated by the component (A) to an equivalent (Y) of an epoxy group of the component (B).
<3> The benzoxazine composition described in <1> or <2>, in which the benzoxazine composition includes the component (B) and the component (C).
<4> The benzoxazine composition described in any one of <1> to <3>, in which the component (B) is at least one selected from the group consisting of a bisphenol A epoxy resin, a bisphenol F epoxy resin, a novolac type epoxy resin, a brominated epoxy resin, a hydrogenated epoxy resin, a bisphenol S epoxy resin, a naphthalene type epoxy resin, a phosphorus-containing epoxy resin, a biphenyl type epoxy resin, a tris(hydroxyphenyl)methane type epoxy resin, a tetraphenylethane type epoxy resin, and a dicyclopentadiene type epoxy resin.
<5> The benzoxazine composition described in any one of <1> to <4>, in which the benzoxazine composition contains the component (A) in an amount of 30% by weight to 99% by weight.
<6> The benzoxazine composition described in any one of <1> to <5>, in which the benzoxazine composition includes the component (C), and the component (C) is contained in the benzoxazine composition in an amount of 1 mol % to 20 mol % relative to ester bonds contained in the component (A).
<7> A cured product obtained by curing the benzoxazine composition described in any one of <1> to <6>.
<8> The cured product described in <7>, further including reinforcing fibers.
<9> A method for repairing a cured product, the method including a step of heating the cured product described in <7> or <8>.
<10> A prepreg or semipreg obtained by impregnating reinforcing fibers with the benzoxazine composition described in any one of <1> to <6>.

### EXAMPLES

An embodiment of the present invention will be described below in more detail through Examples and Comparative Example. The present invention is not limited to the following Examples.

### [Test Method]

### [Structural Analysis of Benzoxazine Compound]

A molecular structure analysis of the benzoxazine compound was carried out with use of a nuclear magnetic resonator (NMR, AVANCEIII 400 MHz manufactured by Bruker Corporation), through ¹H-NMR measurement carried out under conditions where the number of accumulations was 16 and a measurement temperature was room temperature.

### (Molecular Weight Measurement of Benzoxazine Compound)

The molecular weight of the benzoxazine compound was measured with use of a gel permeation chromatograph (GPC) (Prominence UFLC manufactured by Shimadzu Corporation) under the following conditions: the eluent was 0.01 mol/L lithium chloride-containing DMF; three columns of TSKgel GMHHR-M were linked together in series; the flow rate was 1 mL/min; the injection volume was 20 L; the column temperature was 40° C.; an UV detector; the sample of a calibration curve was polystyrene.

### (Glass Transition Temperature (Tg) of Cured Product)

The DSC curve of the cured product was measured with use of a differential scanning calorimeter (DSC, DSC7000X manufactured by Hitachi High-Tech Science Corporation), with a nitrogen flow rate of 40 mL/min, under a condition of 10° C./min. The extrapolated glass transition onset temperature (the intersection of a line obtained by extending to a higher temperature region by extrapolation, the baseline before the inflection point of an obtained DSC curve and the tangent line at the inflection point) determined from the DSC curve was used as the glass transition temperature in the present Examples.

### (Thermal Stability of Cured Product)

A thermogravimetric analyzer (STA7200, manufactured by Hitachi High-Tech Science Corporation) was used to measure a 5% weight loss temperature (Td5) of the cured product in a nitrogen gas stream of 200 mL/min at a temperature increase rate of 5° C./min.

### (Evaluation of Repairability of Cured Product)

After a cut approximately 30 m in width and approximately 2 mm in length was made on the surface of the cured product with a cutter, the cured product was heated in the air at 235° C. for 1 hour. The cut was observed before and after the heating with a digital microscope (VHX-200 manufactured by Keyence Corporation). From the changes in the respective widths of the scratch at three locations which were at or near the left end, the right end, and the center of the cut in the longitudinal direction, the respective repair rates at the three locations of the cut were calculated by the following formula, and the average thereof was determined, and repairability was evaluated accordingly.

$$Repair rate ( \% ) = \{ 1 - ( width ( μ m ) of scratch after heating / width ( μ m ) of \text{} scratch before heating ) \} \times 100$$

### Production Example 1

4-Hydroxybenzoic acid (20.00 g, 0.1448 mol), 1,6-hexanediol (8.5580 g, 0.0724 mol), p-toluenesulfonic acid monohydrate (0.2683 g, 0.0014 mol), diethylene glycol dimethyl ether (20.9437 g), and xylene (3.9560 g) were put in a 200-mL three-necked eggplant flask equipped with a stirrer. Subsequently, the temperature of the three-necked eggplant flask was increased to 140° C. in a nitrogen gas stream, and the contents of the three-necked eggplant flask were stirred for 1.5 hours; thereafter, the temperature of the flask was then increased to 160° C., and the contents were stirred for 1.5 hours, to allow the contents to react together. After that, p-toluenesulfonic acid monohydrate (0.2615 g, 0.0014 mol), diethylene glycol dimethyl ether (0.6291 g), and xylene (7.7026 g) were added to the contents of the three-necked eggplant flask, and the contents were then stirred at 160° C. for another seven hours, to allow the contents to react together. A reaction solution was thus obtained. In the course of the reaction, water azeotropy occurred. Therefore, xylene (7.6695 g) was further added. After the reaction, the reaction solution was cooled to room temperature, methanol (80.00 g) was added to and mixed with the reaction solution for dilution, and the reaction solution was then put into 1 L of pure water. A deposition was collected by suction filtration and washed with methanol. After that, the deposition was redissolved in acetone, and then recrystallized. After a solid obtained by the recrystallization was collected by filtration, the solid was dried in vacuum at 50° C. for seven hours, and hexamethylene bis(4-hydroxybenzoate), which was a target substance, was obtained accordingly. It was confirmed that the target substance was successfully synthesized, by measuring the obtained hexamethylene bis(4-hydroxybenzoate) through ¹H-NMR measurement (the deuterated solvent is DMSO-d6) and observing the following peaks: the peak of a phenolic hydroxyl group at 10.3 ppm; the peaks of the protons of benzene rings derived from hydroxybenzoic acid at 7.8 ppm and 6.8 ppm; the peak of the protons of a methylene group adjacent to a generated ester bond at 4.2 ppm; and the peaks of the protons of methylene groups not adjacent to the ester bond at around 1.7 ppm to 1.9 ppm and 1.5 ppm to 1.4 ppm.

### Production Example 2

Hexamethylene bis(4-hydroxybenzoate) (1.2005 g, 0.0034 mol) obtained in Production Example 1 was put in a 20-mL single-necked eggplant flask equipped with a stirrer, and 4,4′-oxydianiline (0.6704 g, 0.0034 mol), paraformaldehyde (0.4245 g, 0.0141 mol), and ethanol (0.7191 g), and toluene (1.5723 g) were further put in the flask. The temperature of the single-necked eggplant flask was increased to 80° C., and the contents of the single-necked eggplant flask were stirred for 24 hours; thereafter, the single-necked eggplant flask was cooled to room temperature. A reaction solution was thus obtained. Chloroform (25.00 g) was added to the obtained reaction solution for dilution, and methanol (300 g) was then added to the reaction solution, so that a precipitate was obtained. The obtained precipitate was collected by suction filtration, washed with methanol (160 g), and dried in vacuum at room temperature for 17 hours. Accordingly, a benzoxazine compound represented by the above Formula (3) and having two ester bonds per unit structure was obtained. Through the ¹H-NMR measurement (the deuterated solvent was DMSO-d6), the peaks of the protons of methylene groups of the generated benzoxazine rings were observed at 5.5 ppm and 4.6 ppm. It was thus confirmed that the target substance was successfully synthesized. In addition, molecular weights of the obtained benzoxazine compound were evaluated through the GPC measurement. It was shown by the measurement that the number average molecular weight Mn=9,000 and the weight average molecular weight Mw=86,700. The average of n in Formula (3) calculated with use of the Mn was 14.8.

### (Raw Material Compound)

The following are the raw materials used in the following Examples and Comparative Example.

### <Component (A): Benzoxazine Compound>

The benzoxazine compound synthesized in [Production Example 2] and represented by the above Formula (3)

### <Component (B): A Compound Containing at Least One Epoxy Group>

A bisphenol A epoxy resin (JER828EL manufactured by Mitsubishi Chemical Co., Ltd.) represented by the above Formula (4)

### <Component (C): Transesterification Catalyst>

zinc acetate

### Comparative Example 11

The benzoxazine compound (0.0500 g) obtained in Production Example 2 was dissolved in N,N-dimethylacetamide (0.3346 g), so that a solution composition was obtained. After that, the solution composition was poured into a box-shaped container made of a Teflon (registered trademark) film, and underwent heat treatments at 150° C. for two hours, at 180° C. for one hour, at 207° C. for four hours, and at 235° C. for 1.5 hours. The benzoxazine compound was thus cured, and a cured product was obtained accordingly.

### Example 1

A cured product was obtained by a method similar to that used in Comparative Example 1, except that 0.0030 g of zinc acetate, which is the component (C), was further added as a component of the solution composition, and the amount of N,N-dimethylacetamide was 1.0075 g. The amount of the component (C) added was 10 mol % relative to the ester bonds contained in the benzoxazine compound obtained in Production Example 2.

### Example 2

A cured product was obtained by a method similar to that used in Example 1, except that as the component (B), 0.0620 g of bisphenol A epoxy resin was further added as a component of the solution composition, the amount of N,N-dimethylacetamide was 1.5000 g, and heat treatment conditions were: 150° C., two hours; 180° C., one hour; and 207° C., four hours. The amount of the component (B) added was such that the equivalent ratio of the epoxy group to the phenolic hydroxyl group generated during the cure reaction of the benzoxazine compound obtained in Production Example 2 stood at 2:1.

### Example 3

A cured product was obtained by a method similar to that used in Example 2, except that the amount of a bisphenol A epoxy resin was 0.0310 g, and the amount of N,N-dimethylacetamide was 1.3000 g. The amount of the component (B) added was such that the equivalent ratio of the epoxy group to the phenolic hydroxyl group generated during the cure reaction of the benzoxazine compound obtained in Production Example 2 stood at 1:1.

### Example 4

A cured product was obtained by a method similar to that used in Example 2, except that the amount of a bisphenol A epoxy resin was 0.0160 g, and the amount of N,N-dimethylacetamide was 1.3034 g. The amount of the component (B) added was such that the equivalent ratio of the epoxy group to the phenolic hydroxyl group generated during the cure reaction of the benzoxazine compound obtained in Production Example 2 stood at 0.5:1.

### Example 5

A cured product was obtained by a method similar to that used in Comparative Example 1, except that 0.0310 g of a bisphenol A epoxy resin was further added as a component of the solution composition, the amount of N,N-dimethylacetamide was 1.3125 g, and heat treatment conditions were: 150° C., two hours; 180° C., one hour; and 207° C., four hours. The amount of the component (B) added was such that the equivalent ratio of the epoxy group to the phenolic hydroxyl group generated during the cure reaction of the benzoxazine compound obtained in Production Example 2 stood at 1:1.

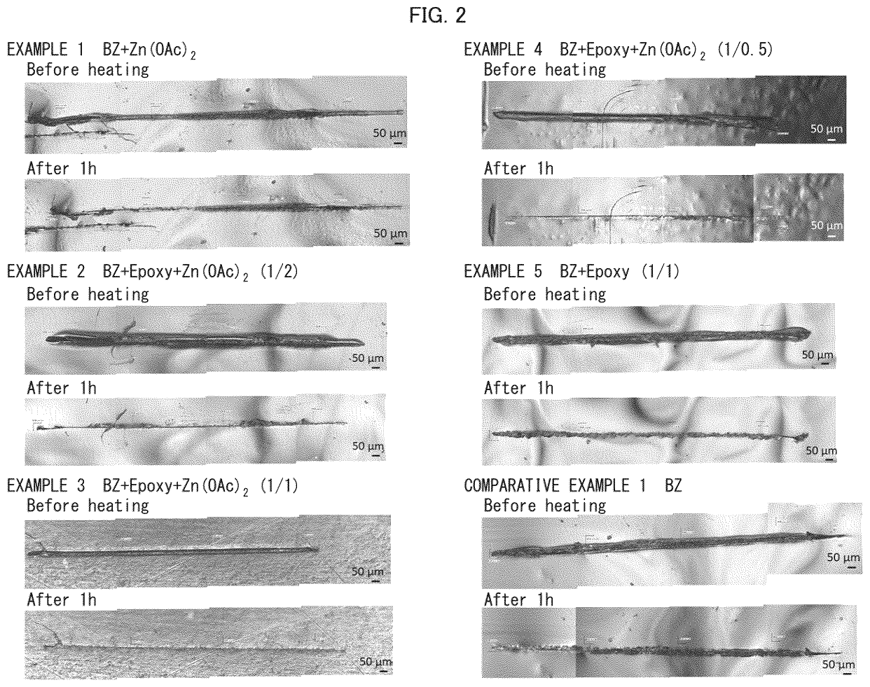

The components of the composition and the physical properties of the cured product are presented for each of Examples and Comparative Example in Table 1 below. Presented in FIG. 2 are observation images of the cuts in Examples and Comparative Example captured by a digital microscope before heating and after the 1-hour heating.

In FIG. 2, “BZ” represents the benzoxazine compound used as the component (A), “Epoxy” represents the epoxy resin used as the component (B), and Zn(OAc)₂ represents zinc acetate used as the component (C). Accordingly, BZ+Epoxy+Zn(OAc)₂ represents the cured product of a mixture of the benzoxazine compound, the epoxy resin, and zinc acetate. In addition, the numerical value (such as (1/1)) appended to a component name represents the ratio (X)/(Y) of the equivalent (X) of the phenolic hydroxyl group derived from the component (A) to the equivalent (Y) of the epoxy group derived from the component (B).

| | | | | | | | Comparative |
|---|---|---|---|---|---|---|---|
| | Material | Example 1 | Example 2 | Example 3 | Example 4 | Example 5 | Example 1 |
| Components | Component (A) | 94.3 | 43.4 | 59.4 | 72.9 | 61.6 | 100 |
| of | (weight ratio) | | | | | | |
| composition | Component (B) | — | 54.0 | 37.0 | 22.7 | 38.4 | — |
| | (weight ratio) | | | | | | |
| | Component (C) | 5.7 | 2.6 | 3.6 | 4.4 | — | — |
| | (weight ratio) | | | | | | |
| | Amount (mol %) of | 10 | 10 | 10 | 10 | — | — |
| | component (C) | | | | | | |
| | relative to | | | | | | |
| | ester bonds contained | | | | | | |
| | in component (A) | | | | | | |
| | Ratio (X)/(Y) of | — | 1/2 = 0.5 | 1/1 = 1 | 1/0.5 = 2 | 1/1 = 1 | — |
| | equivalent (X) of | | | | | | |
| | phenolic hydroxyl group | | | | | | |
| | derived from component | | | | | | |
| | (A) to equivalent (Y) of | | | | | | |
| | epoxy group derived | | | | | | |
| | from component (B) | | | | | | |
| Physical | Item | | | | | | |
| properties | Glass transition | 220 | 158 | 211 | 217 | 167 | 219 |
| | temperature (Tg) (° C.) | | | | | | |
| | 5% Weight loss | 331 | 315 | 313 | 315 | 314 | 327 |
| | temperature (Td5) (° C.) | | | | | | |
| | Average repair rate (%) | 51 | 83 | 79 | 87 | 59 | 21 |

### Conclusion

As can be seen from Table 1 and FIG. 2, Example 1 in which the component (A) and the component (C) were used as components of the composition and Example 5 in which the component (A) and the component (B) were used as components of the composition both have higher cut repair rates than Comparative Example 1 in which the component (A) alone were used.

Further, it is understood that Example 2, Example 3, and Example 4 in which the components (A) to (C) were used as components of the composition have higher cut repair rates than Comparative Example 1, and further have higher cut repair rates than Examples 1 and Example 5.

From the above, it is understood that according to the present invention, the cured product of a composition including the combination of the component (A) and component (B), the combination of the component (A) and the component (C), or the combination of the component (A), component (B), and component (C) exhibits excellent self-repairability.

### INDUSTRIAL APPLICABILITY

The present invention is suitably applicable to electronic materials such as electronic parts, printed wiring boards and laminated boards for a printed wiring board, semiconductor encapsulating materials, and semiconductor-mounted modules, motor vehicles or vehicles, aircraft parts, building materials, machine tools, etc.

1. A benzoxazine composition comprising:
a benzoxazine compound represented by the following Formula (1), the benzoxazine compound being a component (A); and
an epoxy group-containing compound represented by the following Formula (2), the epoxy group-containing compound being a component (B), and/or a transesterification catalyst, which is component (C),
the component (C) being at least one selected from the group consisting of an acidic compound, a basic compound, a phosphorous compound, and a salt of a metal selected from among zinc, tin, zirconium, lead, titanium, manganese, magnesium, antimony, and germanium: 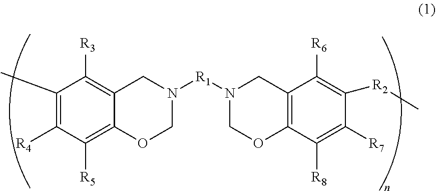
where: n is an integer; R₁ and R₂ are each an aromatic group and/or an aliphatic group, and either R₁ or R₂ or both R₁ and R₂ contain(s) at least one ester group; and R₃ to R₈ each independently represent at least one selected from the group consisting of a hydrogen atom, a halogen atom, an alkyl group, an alkyl halide group, a hydroxy group, a carboxyl group, an amino group, and an alkoxy group, 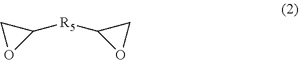
where R₉ is an aromatic group and/or an aliphatic group.

2. The benzoxazine composition according to claim 1,
wherein the benzoxazine composition comprises the component (B), and
when cured, the benzoxazine composition has a ratio (X)/(Y) of not less than 0.25, the ratio (X)/(Y) being a ratio of an equivalent (X) of a phenolic hydroxyl group generated by the component (A) to an equivalent (Y) of an epoxy group of the component (B).

3. The benzoxazine composition according to claim 1, wherein the benzoxazine composition comprises the component (B) and the component (C).

4. The benzoxazine composition according to claim 1, wherein the component (B) is at least one selected from the group consisting of a bisphenol A epoxy resin, a bisphenol F epoxy resin, a novolac type epoxy resin, a brominated epoxy resin, a hydrogenated epoxy resin, a bisphenol S epoxy resin, a naphthalene type epoxy resin, a phosphorus-containing epoxy resin, a biphenyl type epoxy resin, a tris(hydroxyphenyl)methane type epoxy resin, a tetraphenylethane type epoxy resin, and a dicyclopentadiene type epoxy resin.

5. The benzoxazine composition according to claim 1, wherein the benzoxazine composition contains the component (A) in an amount of 30% by weight to 99% by weight.

6. The benzoxazine composition according to claim 1, wherein the benzoxazine composition comprises the component (C), and the component (C) is contained in the benzoxazine composition in an amount of 1 mol % to 20 mol % relative to ester bonds contained in the component (A).

7. A cured product obtained by curing the benzoxazine composition according to claim 1.

8. The cured product according to claim 7, further comprising reinforcing fibers.

9. A method for repairing a cured product, the method comprising a step of heating the cured product according to claim 7.

10. A prepreg or semipreg obtained by impregnating reinforcing fibers with the benzoxazine composition according to claim 1.
